(19) United States
(12) Patent Application Publication
(10) Pub. No.: US 2026/0295503 A1
(43) Pub. Date: Oct. 1, 2026

(54) DAC APPARATUS

(71) Applicant: Honda Motor Co., Ltd., Tokyo (JP)

(72) Inventors: Gou Tamura, Saitama (JP); Hiroka Shigi, Saitama (JP)

(21) Appl. No.: 19/577,332

(22) Filed: Mar. 24, 2026

(30) Foreign Application Priority Data
Mar. 28, 2025 (JP) 2025-055216

(51) Int. Cl. B01D 53/04

(52) U.S. Cl. CPC B01D 53/0454; B01D 2257/504; B01D 2257/80; B01D 2258/06

(57) ABSTRACT

A DAC apparatus to recover CO₂ in the atmosphere, includes: an adsorption chamber provided with an adsorbent for adsorbing or absorbing CO₂ and water; an atmospheric valve to open the adsorption chamber to the atmosphere or seal the adsorption chamber; a vacuum pump connected with the adsorption chamber through vacuum piping; a vacuum valve to permit or prohibit a flow of gas from the adsorption chamber to the vacuum piping; and a controller to control the atmospheric valve and the vacuum valve to alternately perform an adsorption step and a desorption step. The adsorption chamber includes a plurality of adsorption chambers, and when stopping the DAC apparatus, the controller determines at least one of the adsorption chambers as a purging adsorption chamber and controls the atmospheric valve and vacuum valve to open the purging adsorption chamber to the atmosphere and permit the flow of gas to the vacuum piping.

### CROSS-REFERENCE TO RELATED APPLICATION

This application is based upon and claims the benefit of priority from Japanese Patent Application No. 2025-055216 filed on March 28, 2025, the content of which is incorporated herein by reference.

### BACKGROUND OF THE INVENTION

### Field of the Invention

The present invention relates to a direct air capture (DAC) apparatus that recovers carbon dioxide (CO₂) in the atmosphere.

### Description of the Related Art

For the purpose of mitigating climate changes, research and development have been conducted on DAC technology for recovering CO₂, which is a main greenhouse gas. As such a DAC technology, a DAC apparatus that recovers CO₂ in the atmosphere using an adsorbent for adsorbing or absorbing CO₂ is known. For example, in the DAC apparatus of JP2023-161481 A, after an adsorption mode of applying an adsorption potential to an electrochemical cell in which the adsorbent is provided to adsorb CO₂ in the atmosphere is performed, a desorption and recovery mode of applying a desorption potential to desorb CO₂ to recover a desorption gas having a high CO₂ concentration is performed. In addition, after the adsorption mode and before the desorption mode, a purging mode of purging the inside of a collector in which the electrochemical cell is accommodated using a vacuum pump is performed.

However, as in the apparatus described in JP2023-161481 A, by merely purging the inside of the collector using the vacuum pump after the adsorption mode and before the desorption mode, it is difficult to remove moisture in the entire apparatus at the time of operation stop when the operation of the vacuum pump is stopped, and it is difficult to suppress degradation of each unit of the apparatus.

### SUMMARY OF THE INVENTION

An aspect of the present invention is a DAC apparatus configured to recover CO₂ in the atmosphere, including: an adsorption chamber provided with an adsorbent for adsorbing or absorbing CO₂ and water; an atmospheric valve configured to open the adsorption chamber to the atmosphere or seal the adsorption chamber from the atmosphere; a vacuum pump connected with the adsorption chamber through vacuum piping; a vacuum valve configured to permit or prohibit flow of gas from the adsorption chamber to the vacuum piping; and a controller configured to control the atmospheric valve and the vacuum valve to alternately perform an adsorption step and a desorption step, the adsorption step opening the adsorption chamber to the atmosphere, prohibiting the flow of the gas to the vacuum piping, and adsorbing CO₂ in the atmosphere to the adsorbent, the desorption step sealing the adsorption chamber, permitting the flow of the gas to the vacuum piping, and desorbing CO₂ from the adsorbent. The adsorption chamber includes a plurality of the adsorption chambers. When stopping the DAC apparatus, the controller determines at least one of the plurality of adsorption chambers as a purging adsorption chamber out of the plurality of adsorption chambers and controls the atmospheric valve and the vacuum valve to open the purging adsorption chamber to the atmosphere and permit the flow of the gas to the vacuum piping so as to purge the vacuum piping and the vacuum pump.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of a configuration of gas piping of a DAC apparatus according to an embodiment of the present invention;

FIG. 2 is a block diagram schematically illustrating an example of a configuration of heat medium piping of the DAC apparatus according to the embodiment of the present invention;

FIG. 3 is a block diagram schematically illustrating an example of a piping configuration between a heat pump and a high-temperature water tank and a low-temperature water tank shown in FIG. 2;

FIG. 4 is a block diagram schematically illustrating an example of a control configuration of the DAC apparatus according to the embodiment of the present invention;

FIG. 5 is a flowchart illustrating an example of stop processing of the DAC apparatus performed by a controller shown in FIG. 4;

FIG. 6 is a flowchart illustrating an example of low-temperature water temperature management processing performed by the controller shown in FIG. 4;

FIG. 7 is a flowchart illustrating an example of purging reactor determination processing performed by the controller shown in FIG. 4;

FIG. 8 is a diagram for describing flow of gas while in purging in S6 of FIG. 5; and

FIG. 9 is a flowchart illustrating an example of purging processing performed by the controller shown in FIG. 4.

### DETAILED DESCRIPTION OF THE INVENTION

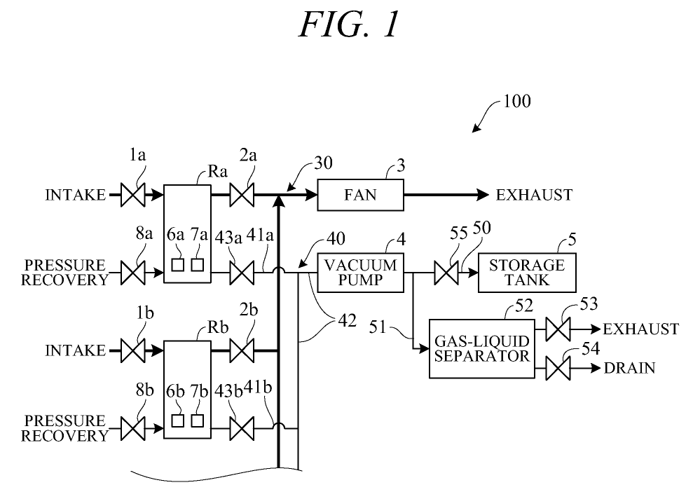

Hereinafter, embodiments of the present invention will be described with reference to FIGS. 1 to 9. FIG. 1 is a block diagram schematically illustrating an example of a configuration of gas piping of a DAC apparatus 100 according to an embodiment of the present invention. As illustrated in FIG. 1, the DAC apparatus 100 mainly includes a plurality of reactors R (Ra, Rb, and so on) in each of which an adsorbent for adsorbing or absorbing CO₂ is provided.

The reactor R includes a housing in which a sealed space (an adsorption chamber) can be formed, and an adsorbent is provided in the adsorption chamber of the reactor R. As the adsorbent, a solid material composed to adsorb CO₂ at normal temperature and normal pressure and to desorb CO₂ as the temperature rises can be used. For example, an amine-based solid absorbent in which an amine-based compound is carried on an appropriate carrier can be used. Such an adsorbent adsorbs or absorbs water in addition to CO₂. The adsorbent is constituted in an appropriate granular shape, is filled in a filter cartridge or the like having a mesh structure, for example, and is accommodated in the adsorption chamber of the reactor R.

Atmospheric valves (control valves) 1 (1a, 1b, and so on) and 2 (2a, 2b, and so on), which open the reactor R to the atmosphere or seal the reactor R from the atmosphere, are provided for the reactor R. The atmospheric valves 1 and 2 may be provided on piping that connects the adsorption chamber with an external space of the reactor R, or may be provided as a part of a housing (a wall surface) of the reactor R. When the atmospheric valves 1 and 2 are opened, the adsorption chamber of the reactor R is opened to the atmosphere. When the atmospheric valves 1 and 2 are closed, the adsorption chamber of the reactor R is sealed. The atmospheric valve 1 and the atmospheric valve 2 are provided to face each other with the adsorption chamber interposed between them.

A fan 3 for circulating the atmosphere into the adsorption chamber of the reactor R is connected with the reactor R through appropriate piping (atmospheric piping) 30 and one of the atmospheric valves 1 and 2 (the atmospheric valve 2 in the illustrated example). In the illustrated example, when the atmospheric valves 1 and 2 are open and the fan 3 is driven, the atmosphere is taken into the reactor R through the atmospheric valve 1, and the atmosphere is exhausted from the reactor R through the atmospheric valve 2, the atmospheric piping 30, and the fan 3. Thus, when the atmosphere circulates into the reactor R, CO₂ in the atmosphere is adsorbed to the adsorbent in the adsorption chamber (an adsorption step). The atmospheric valves 1 and 2 and the atmospheric piping 30 are each configured to have a relatively large diameter so as to enable a large amount of atmosphere to circulate into the reactor R. A plurality of atmospheric valves 1 and a plurality of atmospheric valves 2 may be provided.

Vacuum piping 40 is further connected with the reactor R. The vacuum piping 40 connects the adsorption chamber of the reactor R with an intake port of a vacuum pump 4. More specifically, the vacuum piping 40 includes: individual piping 41 (41a, 41b, and so on), which communicates with the adsorption chamber of each reactor R; and junction piping 42, which joins the individual piping 41 to communicate with the intake port of the vacuum pump 4, and thus connects the individual piping 41 with the vacuum pump 4.

On each individual piping 41, a vacuum valve (a control valve) 43 (43a, 43b, and so on), which permits or prohibits the flow of gas in the individual piping 41, that is, the flow from the reactor R to the vacuum piping 40, is provided. The vacuum valve 43 may be made up of an on-off valve such as a ball valve, may be made up of an adjustment valve such as a butterfly valve, or may be made up of a combination of them. The storage tank 5 is connected with an exhaust port of the vacuum pump 4 through appropriate piping (storage piping) 50. The control valve 43 is closed in an adsorption step.

A gas-liquid separator 52 is connected through branch piping 51 with the storage piping 50 between the vacuum pump 4 and the storage tank 5. As the gas-liquid separator 52, for example, a condenser that cools gas through heat exchange and condenses water can be used. For the gas-liquid separator 52, an exhaust valve 53 and a drain valve 54 are provided. In addition, on the storage piping 50, which is disposed downstream a branch point where the branch piping 51 branches, a storage valve (a control valve) 55, which permits or prohibits the flow of gas to the storage tank 5, is provided.

During the operation of the DAC apparatus 100, the exhaust valve 53 and the drain valve 54 are closed, and the storage valve 55 is open. In this case, the gas flowing from the vacuum pump 4 to the storage tank 5 flows into the gas-liquid separator 52 through the storage piping 50 and the branch piping 51, and is stored in the storage tank 5 after moisture is removed by the gas-liquid separator 52. In addition, the water separated by the gas-liquid separator 52 is stored in a water storage space in the gas-liquid separator 52.

In the reactor R, a heat exchanger 6 (6a, 6b, and so on), which heats or cools the adsorbent, is provided. A high-temperature heat medium having a high temperature (for example, water having a high temperature (high-temperature water)) and a low-temperature heat medium having normal temperature (for example, water having a low temperature (low-temperature water)) in accordance with a desorption temperature of CO₂ are supplied to the heat exchanger 6. The heat exchanger 6 heats the adsorbent when the high-temperature water is supplied, and cools the adsorbent when the low-temperature water is supplied.

In the reactor R, a sensor group 7 (7a, 7b, and so on) is provided, including a pressure sensor that detects pressure P in the adsorption chamber, a CO₂ concentration sensor that detects a CO₂ concentration in the adsorption chamber, and an adsorbent temperature sensor that detects a temperature Ta of the adsorbent (an adsorbent temperature).

When the atmospheric valves 1 and 2 are closed, the vacuum valve 43 is opened, and the vacuum pump 4 is driven, the gas in the adsorption chamber of the reactor R is sucked out by the vacuum pump 4 through the vacuum piping 40. Furthermore, when the adsorbent in the adsorption chamber is heated by the heat exchanger 6, CO₂ that has been adsorbed to the adsorbent in the reactor R is desorbed. The desorption gas mainly containing the desorbed CO₂ is sucked out of the reactor R, is stored in the storage tank 5, and is recovered (a desorption step).

After the adsorption step ends and before the desorption step starts, a deaeration step of deaerating the inside of the adsorption chamber of the reactor R may be performed. The deaeration step may be performed using the vacuum piping 40 and the vacuum pump 4. However, a vacuum pump (a vacuum pump for deaeration) different from the vacuum pump 4 is connected with the adsorption chamber of the reactor R through vacuum piping (vacuum piping for deaeration) different from the vacuum piping 40, and then the deaeration step may be performed using such a vacuum pump for deaeration.

A pressure recovery valve (a control valve) 8 (8a, 8b, and so on), which recovers the pressure in the adsorption chamber of the reactor R, is further provided for the reactor R. The pressure recovery valve 8 may be provided on piping that connects the adsorption chamber of the reactor R with an external space, or may be provided directly on the housing (a wall surface) of the reactor R. The pressure recovery valve 8 is closed in the adsorption step and the desorption step.

After the desorption step ends and before the adsorption step is started, the control valves 1, 2, 8, and 43 are closed, the adsorbent is cooled by the heat exchanger 6. When the adsorbent is cooled down to normal temperature, the pressure recovery valve 8 is opened, and the atmosphere is introduced from the external space to recover the pressure in the adsorption chamber to the atmospheric pressure (a cooling and pressure-recovering step). When the atmosphere containing oxygen circulates into the adsorption chamber in a state in which the adsorbent has a high temperature, the adsorbent may be subject to the oxidation deterioration. By cooling the adsorbent to a temperature range in which an oxidation reaction does not proceed before the atmosphere is introduced into the adsorption chamber and the pressure is recovered, it becomes possible to prevent the oxidation deterioration of the adsorbent.

In the DAC apparatus 100, the adsorption step, the desorption step, and the cooling and pressure-recovering step are sequentially performed in the plurality of reactors R by shifting the timing. More specifically, the sequential order for the plurality of reactors R to perform each step, the duration of each step, and the time interval for shifting the start timing of each step between the reactors R are determined beforehand.

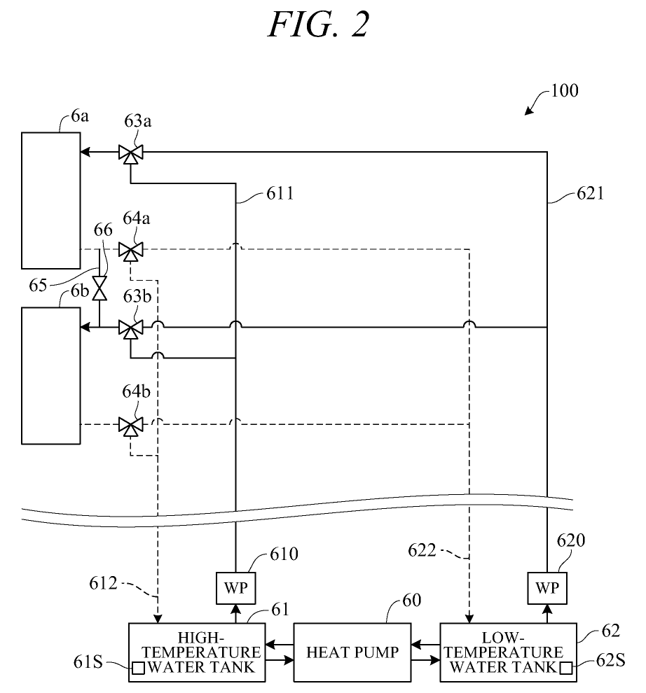

FIG. 2 is a block diagram schematically illustrating an example of a configuration of heat medium piping of the DAC apparatus 100. As illustrated in FIG. 2, in the DAC apparatus 100, a heat pump 60 for supplying high-temperature water and low-temperature water to the heat exchanger 6, which is provided in each reactor R, is provided.

The heat pump 60 includes: an evaporator (a heat exchanger) that evaporates a working fluid; a compressor that compresses the evaporated working fluid; a condenser (a heat exchanger) that condenses the compressed working fluid; and an expansion valve that expands the condensed working medium, and the heat pump 60 transfers heat of low-temperature water to high-temperature water. In the evaporator, the heat of the low-temperature water is absorbed by the working fluid, and the working fluid is evaporated (vaporized) (an evaporation step). In the compressor, a gaseous working fluid is brought into a high-temperature and high-pressure state through adiabatic compression (a compression step). In the condenser, heat of the gaseous working fluid is dissipated to the high-temperature water, and the working fluid is condensed (liquefied) (a condensation step). In the expansion valve, a liquid working fluid is brought into a low-temperature and low-pressure state through adiabatic expansion (an expansion step). The heat pump 60 circulates the working fluid between the low-temperature water and the high-temperature water, and repeats the evaporation step, the compression step, the condensation step, and the expansion step to transfer the heat of the low-temperature water to the high-temperature water.

In the heat pump 60, the rotation speed of the compressor is adjusted in such a manner that the temperature of the high-temperature water is raised to a target temperature set beforehand in accordance with a desorption temperature (for example, approximately 100 degrees Celsius) of CO₂. That is, the rotation speed of the compressor is adjusted in such a manner that the temperature of the high-temperature water coming out of the heat pump 60 becomes a target temperature in accordance with the temperature of the high-temperature water entering the heat pump 60. In the heat pump 60, the heat absorbed from the low-temperature water by the evaporator is dissipated to the high-temperature water by the condenser, and thus the temperature of the high-temperature water increases. Therefore, as the temperature rise width of the high-temperature water increases, the temperature drop width of the low-temperature water increases. As the rotation speed of the compressor increases and the load (power consumption) of the heat pump 60 increases, the temperature rise width of the high-temperature water and the temperature drop width of the low-temperature water increase.

A high-temperature water tank 61, which stores high-temperature water to be circulated to the condenser of the heat pump 60, and a low-temperature water tank 62, which stores low-temperature water to be circulated to the evaporator of the heat pump 60, are connected with the heat pump 60 through appropriate piping. In the high-temperature water tank 61, a high-temperature water temperature sensor 61S, which detects a temperature TwH of the high-temperature water (a temperature of the high-temperature water), is provided. In the low-temperature water tank 62, a low-temperature water temperature sensor 62S, which detects a temperature TwL of the low-temperature water (a temperature of the low-temperature water), is provided.

The high-temperature water tank 61 and the low-temperature water tank 62 are further connected with the heat exchanger 6 of each reactor R through appropriate piping, and the high-temperature water stored in the high-temperature water tank 61 and the low-temperature water stored in the low-temperature water tank 62 are circulated to the heat exchanger 6 of each reactor R through piping.

More specifically, the high-temperature water stored in the high-temperature water tank 61 flows through a flow passage 611, on which a water supply pump 610 is provided, at a flow rate corresponding to the rotation speed of the water supply pump 610, and is supplied to the heat exchanger 6 of each reactor R. After the adsorbent of each reactor R is heated, the high-temperature water discharged from the heat exchanger 6 flows through a flow passage 612, and returns to the high-temperature water tank 61.

Similarly, the low-temperature water stored in the low-temperature water tank 62 flows through a flow passage 621, on which a water supply pump 620 is provided, at a flow rate corresponding to the rotation speed of the water supply pump 620, and is supplied to the heat exchanger 6 of each reactor R. After the adsorbent of each reactor R is cooled, the low-temperature water discharged from the heat exchanger 6 flows through a flow passage 622, and returns to the low-temperature water tank 62.

A heat medium switch valve (a three-way proportional control valve) 63 (63a, 63b, and so on), which switches whether to supply the high-temperature water from the flow passage 611 or to supply the low-temperature water from the flow passage 621, as a heat medium flowing through the heat exchanger 6, is provided at an inlet of the heat exchanger 6 of each reactor R. A heat medium switch valve (a three-way proportional control valve) 64 (64a, 64b, and so on), which switches whether to return the heat medium that has been discharged from the heat exchanger 6 to the flow passage 612 or to return the heat medium that has been discharged from the heat exchanger 6 to the flow passage 622, is provided at an outlet of the heat exchanger 6 of each reactor R. The heat medium switch valves 63 and 64 are each capable of adjusting the flow rate of the heat medium (the high-temperature water or the low-temperature water) flowing through the heat exchanger 6, and are each capable of switching whether or not to flow the heat medium through the heat exchanger 6. The heat medium switch valves 63 and 64 are controlled in such a manner that the high-temperature water is circulated through the flow passages 611 and 612 to the heat exchanger 6 of the reactor R in the desorption step and the low-temperature water is circulated through the flow passages 621 and 622 to the heat exchanger 6 of the reactor R in the cooling and pressure-recovering step.

A bypass flow passage 65 is provided between the heat medium switch valves 63 and 64 of each reactor R and an inlet of the heat exchanger 6. The bypass flow passage 65 connects an inlet of the heat exchanger 6 of one reactor R with an outlet of the heat exchanger 6 of another reactor R, and causes the heat medium (the high-temperature water or the low-temperature water) from the flow passage 611 or the flow passage 621 to bypass the heat exchanger 6 and return the heat medium to the flow passage 612 or the flow passage 622. In the example of FIG. 2, the bypass flow passage 65 connects an inlet of the heat exchanger 6b of the reactor Rb with an outlet of the heat exchanger 6a of the reactor Ra, and causes the heat medium from the flow passage 611 or the flow passage 621 to bypass the heat exchanger 6b and return the heat medium to the flow passage 612 or the flow passage 622. On the bypass flow passage 65, a bypass valve (a control valve) 66, which permits or prohibits the flow of the heat medium in the bypass flow passage 65, is provided. During the operation of the DAC apparatus 100, the bypass valve 66 is closed.

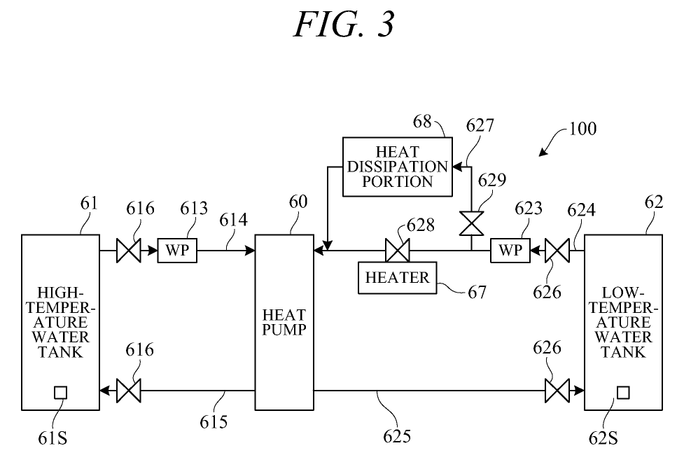

FIG. 3 is a block diagram schematically illustrating an example of a piping configuration between the heat pump 60 in FIG. 2 and the high-temperature water tank 61 and the low-temperature water tank 62. As illustrated in FIG. 3, the high-temperature water stored in the high-temperature water tank 61 flows through a flow passage 614, on which a water supply pump 613 is provided, at a flow rate corresponding to the rotation speed of the water supply pump 613, enters the condenser of the heat pump 60, and is heated to a target temperature by heat dissipation from a working fluid. The high-temperature water that has been heated to the target temperature by the heat pump 60 flows through a flow passage 615, and returns to the high-temperature water tank 61. On each of the flow passages 614 and 615, an on-off valve (a control valve) 616, which permits or prohibits circulation of the high-temperature water between the heat pump 60 and the high-temperature water tank 61, is provided.

Similarly, the low-temperature water stored in the low-temperature water tank 62 flows through a flow passage 624, on which a water supply pump 623 is provided, at a flow rate corresponding to the rotation speed of the water supply pump 623, enters the evaporator of the heat pump 60, and is cooled by heat absorption to the working fluid. The low-temperature water that has been cooled by the heat pump 60 flows through a flow passage 625, and returns to the low-temperature water tank 62. On each of the flow passages 624 and 625, an on-off valve (a control valve) 626, which permits or prohibits circulation of the low-temperature water between the heat pump 60 and the low-temperature water tank 62, is provided. A part of the flow passage 625 from the heat pump 60 to the low-temperature water tank 62 is provided in close contact with the vacuum pump 4 in FIG. 1, and thus the vacuum pump 4 is cooled by the low-temperature water that has been cooled by the heat pump 60.

On the flow passage 624 from the low-temperature water tank 62 to the heat pump 60, a heater 67, which heats the low-temperature water flowing in the flow passage 624, is provided. A flow passage 627, which bypasses the heater 67, is connected with the flow passage 624. On the flow passage 627, a heat dissipation portion 68, which dissipates heat of the low-temperature water flowing through the flow passage 627, is provided. The heat dissipation portion 68 includes: a heat exchanger through which the low-temperature water flows; and a fan for air-cooling such a heat exchanger. The heat dissipation portion 68 promotes heat exchange between the low-temperature water and outside air, and cools the low-temperature water. In the heat dissipation portion 68, the low-temperature water before being cooled by the heat pump 60 is cooled. An on-off valve (a control valve) 628, which permits or prohibits the flow of the low-temperature water to pass through the heater 67, is provided on the flow passage 624 from the branch point to the junction point of the flow passage 627, and an on-off valve (a control valve) 629, which permits or prohibits the flow of the low-temperature water to pass through the heat dissipation portion 68, is provided on the flow passage 627.

The heat pump 60 transfers the heat of the low-temperature water to the high-temperature water to raise the temperature of the high-temperature water to a target temperature. Therefore, during the operation of the heat pump 60, it is necessary to manage the temperature of the low-temperature water entering the heat pump 60 so as to fall within an appropriate temperature range. During the operation of heat pump 60, the heater 67, the heat dissipation portion 68 (a fan), and on-off valves 628 and 629 are controlled in such a manner that the temperature TwL of the low-temperature water that has been detected by the low-temperature water temperature sensor 62S falls within an appropriate temperature range.

During the operation of the DAC apparatus 100, a desorption gas having a high-temperature and containing water vapor flows into the vacuum piping 40 and the vacuum pump 4 in FIG. 1 from the reactor R in the desorption step. When the operation of such a DAC apparatus 100 is stopped, the temperatures of the vacuum piping 40 and the vacuum pump 4 are lowered. Therefore, when the DAC apparatus is left in a state in which a desorption gas containing water vapor remains, each unit of the apparatus may be degraded by the water condensed inside the vacuum piping 40 and the vacuum pump 4. Therefore, in the present embodiment, the DAC apparatus 100 is configured as follows in such a manner that the vacuum piping 40 and the vacuum pump 4 are purged to remove moisture of the entire apparatus when the operation of the DAC apparatus 100 is stopped, so that the degradation of each unit of the entire apparatus can be suppressed.

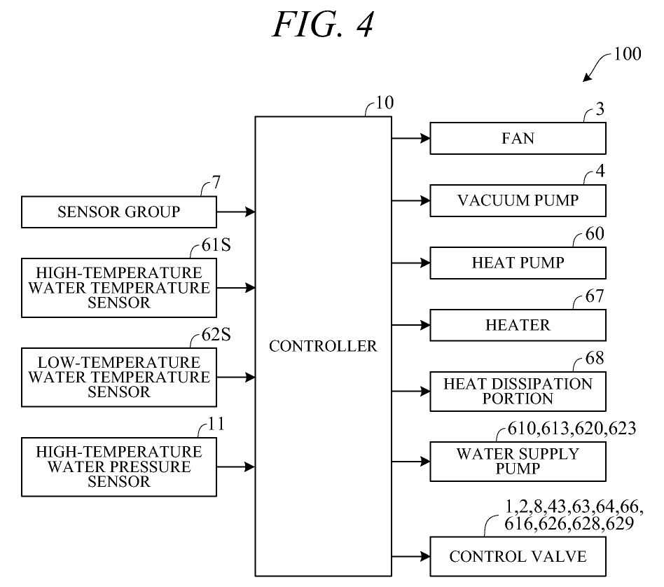

FIG. 4 is a block diagram schematically illustrating an example of a control configuration of the DAC apparatus 100. As illustrated in FIG. 4, the DAC apparatus 100 includes a controller 10, which controls each unit of the DAC apparatus 100 including the fan 3, the vacuum pump 4, the heat pump 60, the heater 67, the heat dissipation portion 68 (the fan), the water supply pumps 610, 613, 620, and 623, and the control valves 1, 2, 8, 43, 63, 64, 66, 616, 626, 628, and 629 in FIGS. 1 to 3. The controller 10 is made up of a computer including a CPU, a ROM, a RAM, an I/O interface, and other peripheral circuits.

In the DAC apparatus 100, a high-temperature water pressure sensor 11, which is provided on the flow passage 611 in FIG. 2 through which the high-temperature water flows, and which detects the pressure (water pressure) of the high-temperature water, is also provided. The sensor group 7, the high-temperature water temperature sensor 61S, the low-temperature water temperature sensor 62S, and the high-temperature water pressure sensor 11 in FIGS. 1 to 3 are connected with the controller 10, and a signal indicating a detection value of each sensor is input into the controller 10.

When the DAC apparatus 100 is activated, the controller 10 controls each unit of the DAC apparatus 100 so that the adsorption step, the desorption step, and cooling and pressure-recovering step are sequentially performed in the plurality of reactors R by shifting the timing. In addition, when stop of the DAC apparatus 100 is requested, the controller 10 performs stop processing of the DAC apparatus 100 including purging processing.

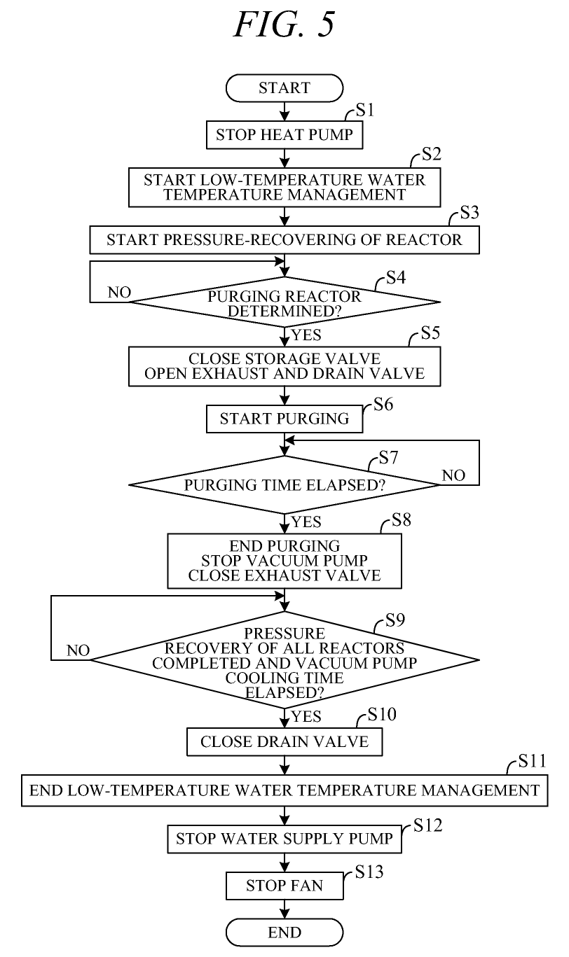

FIG. 5 is a flowchart illustrating an example of the stop processing of the DAC apparatus 100 performed by the controller 10. As illustrated in FIG. 5, in the stop processing of the DAC apparatus 100, the controller 10 first controls and stops the heat pump 60 in S1 (S: processing step). In a case where the vacuum pump for deaeration is provided, the vacuum pump for deaeration is also controlled to be stopped. Next, in S2, low-temperature water temperature management processing for managing the temperature TwL of the low-temperature water is started. In stopping the DAC apparatus 100, it is possible to suppress the power consumption during the stop processing, by stopping the heat pump 60 early.

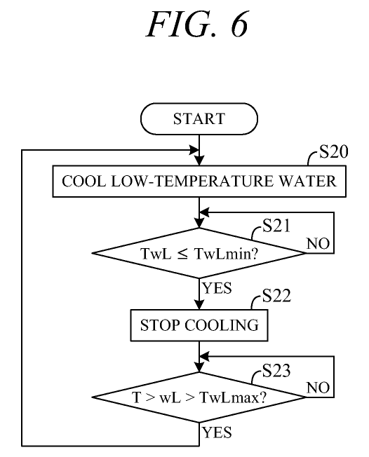

FIG. 6 is a flowchart illustrating an example of the low-temperature water temperature management processing performed by the controller 10. As illustrated in FIG. 6, in the low-temperature water temperature management processing, the controller 10 first controls and opens the on-off valve 628 and the on-off valve 629 in FIG. 3, and drives the heat dissipation portion 68 (the fan) in step S20. Thus, some amount of the low-temperature water is cooled by the heat dissipation portion 68 instead of the heat pump 60 stopped in S1.

Next, in S21, it is determined whether the temperature TwL of the low-temperature water that has been detected by the low-temperature water temperature sensor 62S is equal to or lower than a lower limit temperature TwLmin (for example, approximately 15 degrees Celsius). S21 is repeated until an affirmative determination is made. In a case where the affirmative determination is made in S21, the processing proceeds to S22, and the on-off valve 629 in FIG. 3 is controlled to be closed and the heat dissipation portion 68 (the fan) is also stopped. Thus, cooling of the low-temperature water in the heat dissipation portion 68 is stopped.

Next, in S23, it is determined whether the temperature TwL of the low-temperature water that has been detected by the low-temperature water temperature sensor 62S exceeds an upper limit temperature TwLmax (for example, approximately 20 degrees Celsius). S23 is repeated until an affirmative determination is made. In a case where the affirmative determination is made in S23, the processing returns to S20, and cooling of the low-temperature water in the heat dissipation portion 68 is resumed. Note that in step S22 of the low-temperature water temperature management processing in FIG. 6, in addition to stopping cooling the low-temperature water in the heat dissipation portion 68, the heater 67 in FIG. 3 may be driven to heat the low-temperature water. In this case, in S20, in addition to resuming cooling the low-temperature water in the heat dissipation portion 68, the heater 67 is stopped to stop heating the low-temperature water. Thus, it becomes possible to prevent the vacuum pump 4 from being excessively cooled by the low-temperature water during the stop processing of the DAC apparatus 100. In this manner, also after the heat pump 60 is stopped, by maintaining the temperature TwL of the low-temperature water within an appropriate temperature range using the heat dissipation portion 68 and the heater 67, it becomes possible to appropriately cool the vacuum pump 4 while suppressing the power consumption during the stop processing of the DAC apparatus 100, and to continue the stable operation.

In the stop processing of the DAC apparatus 100 in FIG. 5, after the low-temperature water temperature management processing in FIG. 6 is started in S2, the processing proceeds to S3, and starts purging reactor determination processing of recovering each reactor R, and determining a purging reactor R to be used for purging the vacuum piping 40 and the vacuum pump 4.

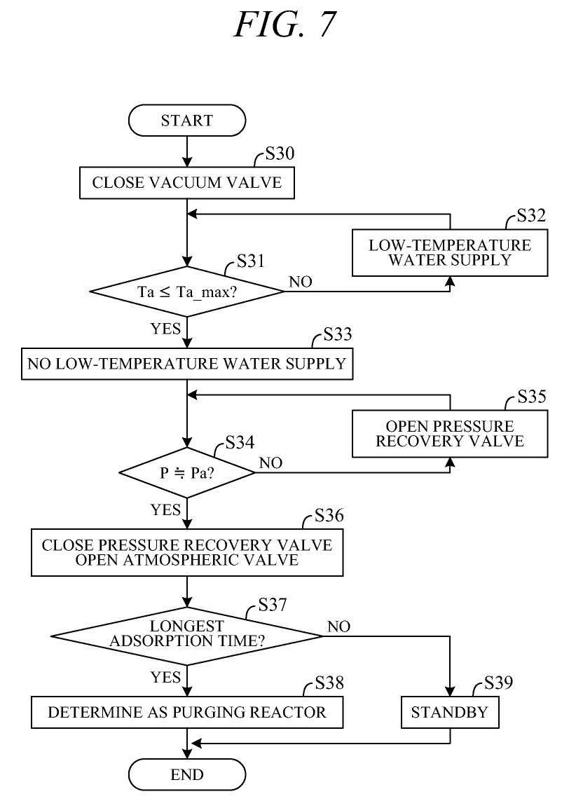

FIG. 7 is a flowchart illustrating an example of the purging reactor determination processing performed by the controller 10. The purging reactor determination processing in FIG. 7 is performed for every reactor R. As illustrated in FIG. 7, in the purging reactor determination processing, the controller 10 first controls and closes the vacuum valve 43 in S30 to prohibit the flow of the gas from a target reactor R to the vacuum piping 40.

Next, in S31, it is determined whether the adsorbent temperature Ta that has been detected by the sensor group 7 (an adsorbent temperature sensor) is equal to or lower than an upper limit temperature Ta_max (for example, approximately 30 degrees Celsius) at which an oxidation reaction of the adsorbent does not proceed. In a case where a negative determination is made in step S31, the processing proceeds to step S32. The heat medium switch valves (the control valves) 63 and 64 (FIG. 2) are controlled to supply (pass) the low-temperature water to the heat exchanger 6 of the target reactor R, and the processing returns to step S31. Thus, the adsorbent of the target reactor R is cooled by the low-temperature water through the heat exchanger 6. In a case where an affirmative determination is made in S31, the processing proceeds to S33, and the heat medium switch valves (the control valves) 63 and 64 are controlled not to cause the low-temperature water to pass through the heat exchanger 6 of the target reactor R. Thus, cooling of the adsorbent using the low-temperature water is stopped.

Next, in S34, it is determined whether the pressure P in the adsorption chamber that has been detected by the sensor group 7 (the pressure sensor) is approximately the atmospheric pressure Pa. In a case where a negative determination is made in S34, the processing proceeds to S35 to control and open the pressure recovery valve 8 of the target reactor R, and the processing returns to S34. Thus, the atmosphere is gradually introduced through the pressure recovery valve 8, and thus the reactor R that is not open to the atmosphere is gradually recovered to the atmospheric pressure. In a case where an affirmative determination is made in S34, the processing proceeds to S36, and the pressure recovery valve 8 of the target reactor R is controlled to be closed and the atmospheric valves 1 and 2 are controlled to be opened. Thus, the target reactor R is open to the atmosphere, and the pressure recovery is completed.

Next, in S37, it is determined whether the target reactor R is a reactor R in which the adsorption step was started first out of the reactors R in each of which the adsorption step was being performed when the stop of the DAC apparatus 100 was requested. In a case where an affirmative determination is made in S37, the processing proceeds to S38, and the target reactor R is determined as the purging reactor R. In a case where a negative determination is made in S37, the processing proceeds to S39, the target reactor R is determined as a reactor R other than the purging reactor R, and a standby state is set in which the pressure recovery is completed and the stop of the DAC apparatus 100 is waited for.

The reactor R in which the adsorption step is being performed when the stop of the DAC apparatus 100 is requested has been already at normal temperature and normal pressure, and the completion of the pressure recovery is confirmed in S30 to S36 earlier than the reactor R in the desorption step or the cooling and pressure-recovering step. In this manner, by determining the reactor R in which the adsorption step was started first as the purging reactor R out of the reactors R in each of which the completion of the pressure recovery is confirmed early, it becomes possible to determine the purging reactor R early.

The reactor R determined as the purging reactor R is the reactor R, in which the adsorption step was started first out of the reactors R in the adsorption step, and which has the longest adsorption time and the largest adsorption amount. When the operation of the DAC apparatus 100 is restarted, the desorption step is started from the reactor R having the largest adsorption amount in order to efficiently recover CO₂. That is, the desorption step is sequentially started in a predetermined sequential order from the reactor R in which the adsorption step was started first out of the reactors R in the adsorption step.

In the stop processing of the DAC apparatus 100 of FIG. 5, after the purging reactor determination processing of FIG. 7 is started in S3, the processing proceeds to S4, and it is determined whether the purging reactor R is determined. S4 is repeated until an affirmative determination is made. In a case where the affirmative determination is made in S4, the processing proceeds to S5, and the storage valve 55 in FIG. 1 is controlled to be closed, and the exhaust valve 53 and the drain valve 54 are controlled to be opened. Thus, exhaust gas from the vacuum pump 4 is discharged through the branch piping 51 and the gas-liquid separator 52. Next, in S6, the vacuum valve 43 of the purging reactor R is controlled to be opened, and the purging processing of the vacuum piping 40 and the vacuum pump 4 is started.

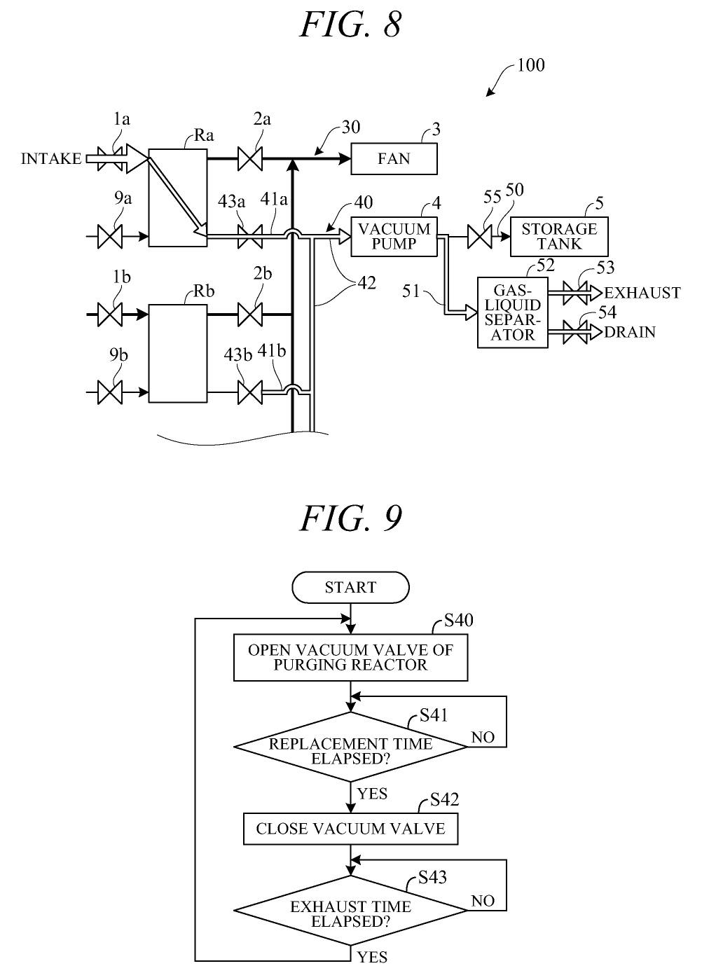

FIG. 8 is a diagram for describing the flow of the gas while in purging in S6 of FIG. 5. As illustrated in FIG. 8, when purging is started, the vacuum valve 43 is closed in S30 of FIG. 7, the pressure recovery valve 8 is closed in S36, and the vacuum valve 43 is opened for the purging reactor R in a state in which the atmospheric valves 1 and 2 are open. For the reactors R other than the purging reactor R, the vacuum valve 43 is closed in S30 of FIG. 7. Thus, the atmosphere that has flowed into the purging reactor R through the atmospheric valves 1 and 2 flows through the vacuum piping 40 and the vacuum pump 4, and the desorption gas remaining in the vacuum piping 40 and the vacuum pump 4 is replaced with the atmosphere (a replacement step). While in purging, the fan 3 circulates the atmosphere into the adsorption chambers of the reactors R that have been opened to the atmosphere, including the purging reactor R. Thus, CO₂ in the atmosphere is adsorbed to the adsorbent, and the adsorption amount further increases.

FIG. 9 is a flowchart illustrating an example of the purging processing performed by the controller 10. As illustrated in FIG. 9, in the purging processing, the controller 10 first controls and opens the vacuum valve 43 of the purging reactor R, and starts the replacement step in S40. Next, in S41, it is determined whether a predetermined replacement time (for example, approximately five minutes) has elapsed since the replacement step was started in S40. S41 is repeated until an affirmative determination is made. In a case where the affirmative determination is made in S41, the processing proceeds to S42, and the vacuum valve 43 of the purging reactor R is controlled to be closed, and the replacement step is stopped. Thus, the gas in the vacuum piping 40 is sucked out by the vacuum pump 4, and is exhausted through the branch piping 51 and the gas-liquid separator 52 (an exhaust step). Next, in S43, it is determined whether a predetermined exhaust time (for example, approximately one minute) has elapsed since the exhaust step was started in S42. S43 is repeated until an affirmative determination is made. In a case where the affirmative determination is made in S43, the processing returns to S40, the vacuum valve 43 of the purging reactor R is controlled to be opened, the exhaust step is stopped, and the replacement step is resumed.

In the exhaust step, the gas containing water vapor in the vacuum piping 40 is exhausted, and the total pressure and the water vapor partial pressure decrease to be equal to or lower than the saturated vapor pressure. The water that adheres to the inside of the vacuum piping 40 evaporates, and is exhausted. Thus, the moisture in the vacuum piping 40 and the vacuum pump 4 can be removed and dried. On the other hand, when the inside of the vacuum piping 40 is excessively cooled by the heat of vaporization generated when water evaporates, the temperature and pressure return to normal temperature and normal pressure after purging, and then moisture in the air adheres again. By alternately repeating the exhaust step and the replacement step of circulating the atmosphere at normal temperature and normal pressure, it becomes possible to prevent the inside of the vacuum piping 40 from being excessively cooled, and to prevent moisture from adhering again after the purging ends. Note that in the purging processing of FIG. 9, an intermittent operation of alternately repeating driving the vacuum pump 4 and stopping the vacuum pump 4 may be performed. Such an intermittent operation of the vacuum pump 4 may be performed only in the exhaust step, or may be performed in the exhaust step and the replacement step. By performing the intermittent operation of the vacuum pump 4 in the purging processing, it becomes possible to prevent the inside of the vacuum piping 40 from being excessively cooled, and to prevent moisture from adhering again after the purging ends.

In the stop processing of the DAC apparatus 100 in FIG. 5, after the purging processing in FIG. 9 is started in S6, the processing proceeds to S7, and it is determined whether a predetermined purging time (for example, approximately one hour) has elapsed. S7 is repeated until an affirmative determination is made. In a case where the affirmative determination is made in S7, the processing proceeds to S8, the vacuum pump 4 is stopped, the exhaust valve 53 is controlled to be closed, and the purging processing of the vacuum piping 40 and the vacuum pump 4 in FIG. 9 ends.

Next, in S9, it is determined whether the pressure recovery of all the reactors R has been completed in the processing of FIG. 7 and a predetermined cooling time has elapsed since the vacuum pump 4 stopped in S8. S9 is repeated until an affirmative determination is made. In a case where the affirmative determination is made in S9, the processing proceeds to S10, and the drain valve 54 is controlled to be closed. Next, in S11, the low-temperature water temperature management processing of FIG. 6 ends, and the heat dissipation portion 68 (the fan) of FIG. 3 is stopped and the on-off valve 629 is controlled to be closed. Next, in step S12, the water supply pumps 610 and 620 are stopped, and furthermore, the water supply pumps 613 and 623 are stopped. Next, in S13, the fan 3 is controlled to be stopped.

In this manner, the fan 3 is continuously driven while in purging, and the vacuum piping 40 and the vacuum pump 4 are purged while the atmosphere is being circulated into the purging reactor R, so that the CO₂ adsorption amount of the purging reactor R can be further increased. When the operation of the DAC apparatus 100 is restarted, the CO₂ adsorption amount of the purging reactor R in which the desorption step is started first is further increased while in purging, so that CO₂ can be more efficiently recovered.

According to the embodiments of the present invention, the following operation and effects are achievable.

1 The DAC apparatus 100 includes: the reactor R in which an adsorbent for adsorbing or absorbing CO₂ and water is provided; the atmospheric valves 1 and 2, which open the reactor R to the atmosphere or seal the reactor R from the atmosphere; the vacuum pump 4 connected with the reactor R through the vacuum piping 40; the vacuum valve 43, which permits or prohibits the flow of gas from the reactor R to the vacuum piping 40; and the controller 10 configured to control the atmospheric valves 1 and 2 and the vacuum valve 43 to alternately perform an adsorption step and a desorption step, the adsorption step opening the reactor R to the atmosphere, prohibiting the flow of the gas to the vacuum piping 40, and adsorbing CO₂ in the atmosphere to the adsorbent, the desorption step sealing the reactor R, permitting the flow of the gas to the vacuum piping 40, and desorbing CO₂ from the adsorbent (FIGS. 1 and 4).

A plurality of reactors R are provided (FIG. 1). In stopping the DAC apparatus 100, the controller 10 determines at least one reactor R as the purging reactor R out of the plurality of reactors R, and controls the atmospheric valves 1 and 2 and the vacuum valve 43 to open the purging reactor R to the atmosphere and permit the flow of the gas to the vacuum piping 40 so as to purge the vacuum piping 40 and the vacuum pump 4 (FIGS. 5, 7, and 8). Thus, the vacuum piping 40 and the vacuum pump 4 through which the desorption gas containing water vapor flows can be replaced with and purged by the atmosphere at normal temperature and normal pressure that has been introduced from the purging reactor R, and moisture in the entire apparatus can be removed when the operation of the DAC apparatus 100 is stopped.

2 The DAC apparatus 100 further includes the fan 3, which circulates the atmosphere into the reactor R (FIG. 1). The controller 10 controls the atmospheric valves 1 and 2, the fan 3, and the vacuum valve 43 to purge the vacuum piping 40 and the vacuum pump 4, and then controls and stops the fan 3 (FIG. 5). The fan 3 is continuously driven while in purging, and the vacuum piping 40 and the vacuum pump 4 are purged while the atmosphere is circulated into the purging reactor R, so that the CO₂ adsorption amount of the purging reactor R can be further increased. When the operation of the DAC apparatus 100 is restarted, the CO₂ adsorption amount of the purging reactor R in which the desorption step is started first is further increased while in purging, so that CO₂ can be more efficiently recovered.

3 The DAC apparatus 100 further includes: the heat exchanger 6 provided to be capable of exchanging heat with the adsorbent; and the heat pump 60, which cools the vacuum pump 4, and which transfers the heat from the low-temperature water that cools the adsorbent through the heat exchanger 6 to the high-temperature water that heats the adsorbent through the heat exchanger 6 (FIGS. 1 and 2). In stopping the operation of the DAC apparatus 100, the controller 10 controls and stops the heat pump 60, and then controls the atmospheric valves 1 and 2 and the vacuum valve 43 to purge the vacuum piping 40 and the vacuum pump 4 (FIG. 5). In this manner, by stopping the heat pump 60 early, it becomes possible to suppress power consumption during the stop processing of the DAC apparatus 100.

4 The DAC apparatus 100 further includes: the low-temperature water temperature sensor 62S, which detects the temperature TwL of the low-temperature water; the heater 67, which heats the low-temperature water; and the heat dissipation portion 68, which cools the low-temperature water (FIG. 3). When the temperature TwL of the low-temperature water that has been detected by the low-temperature water temperature sensor 62S exceeds the upper limit temperature TwLmax, the controller 10 controls the heat dissipation portion 68 (the fan) to cool the low-temperature water (FIG. 6). In addition, when the temperature TwL of the low-temperature water that has been detected by the low-temperature water temperature sensor 62S is equal to or lower than the lower limit temperature TwLmin, the heater 67 is controlled to heat the low-temperature water. In this manner, also after the heat pump 60 is stopped, by maintaining the temperature TwL of the low-temperature water within an appropriate temperature range using the heat dissipation portion 68 and the heater 67, it becomes possible to appropriately cool the vacuum pump 4 while suppressing the power consumption during the stop processing of the DAC apparatus 100, and to continue the stable operation.

5 In the plurality of reactors R, the adsorption step and the desorption step are sequentially performed by shifting the timing. Out of the reactors R in each of which the adsorption step is being performed, the reactor R in which the adsorption step was started first is determined as the purging reactor R (S37 to S38 in FIG. 7). At the timing when the stop of the DAC apparatus 100 is requested, the reactor R in the adsorption step in which the adsorption step is being performed has been already at normal temperature and normal pressure, and the pressure recovery has been completed. In this manner, by determining the purging reactor R from the reactors R in which the pressure recovery is completed, the purging reactor R can be determined early, and then purging can be conducted.

6 In the plurality of reactors R, the sequential order of performing the adsorption step and the desorption step is determined beforehand. The operation of the DAC apparatus 100 is stopped, and then in restarting the operation of the DAC apparatus 100, the controller 10 controls the atmospheric valves 1 and 2 and the vacuum valve 43 to sequentially perform the desorption step from the reactor R that has been determined as the purging reactor R in accordance with a predetermined sequential order. The reactor R determined as the purging reactor R is the reactor R, in which the adsorption step was started first out of the reactors R in the adsorption step, and which has the longest adsorption time and the largest adsorption amount. Furthermore, the atmosphere circulates into the purging reactor R while in purging, and thus CO₂ in the atmosphere is adsorbed to the adsorbent, and the adsorption amount further increases. When the operation of the DAC apparatus 100 is restarted, the desorption step is started from the purging reactor R having the largest adsorption amount, so that CO₂ can be efficiently recovered.

7 In purging the vacuum piping 40 and the vacuum pump 4, the controller 10 controls the vacuum valve 43 to repeat permission and prohibition of the flow of the gas from the purging reactor R to the vacuum piping 40 at predetermined time intervals. In addition, the vacuum pump 4 is controlled to perform the intermittent operation of alternately repeating drive and stop. Thus, the inside of the vacuum piping 40 can be prevented from being excessively cooled, and moisture can be prevented from adhering again after purging ends.

The above embodiment can be combined as desired with one or more of the aforesaid modifications. The modifications can also be combined with one another.

According to the present invention, it becomes possible to remove moisture in the entire apparatus when stopping the operation.

Above, while the present invention has been described with reference to the preferred embodiments thereof, it will be understood, by those skilled in the art, that various changes and modifications may be made thereto without departing from the scope of the appended claims.

1. A DAC apparatus configured to recover CO₂ in the atmosphere, comprising:
an adsorption chamber provided with an adsorbent for adsorbing or absorbing CO₂ and water;
an atmospheric valve configured to open the adsorption chamber to the atmosphere or seal the adsorption chamber from the atmosphere;
a vacuum pump connected with the adsorption chamber through vacuum piping;
a vacuum valve configured to permit or prohibit a flow of gas from the adsorption chamber to the vacuum piping; and
a controller configured to control the atmospheric valve and the vacuum valve to alternately perform an adsorption step and a desorption step, the adsorption step opening the adsorption chamber to the atmosphere, prohibiting the flow of the gas to the vacuum piping, and adsorbing CO₂ in the atmosphere to the adsorbent, the desorption step sealing the adsorption chamber, permitting the flow of the gas to the vacuum piping, and desorbing CO₂ from the adsorbent, wherein
the adsorption chamber includes a plurality of adsorption chambers, wherein
when stopping the DAC apparatus, the controller determines at least one of the plurality of adsorption chambers as a purging adsorption chamber out of the plurality of adsorption chambers and controls the atmospheric valve and the vacuum valve to open the purging adsorption chamber to the atmosphere and permit the flow of the gas to the vacuum piping so as to purge the vacuum piping and the vacuum pump.

2. The DAC apparatus according to claim 1, further comprising:
a fan configured to circulate the atmosphere into the adsorption chamber, wherein
the controller controls the atmospheric valve, the fan, and the vacuum valve to purge the vacuum piping and the vacuum pump and then controls and stops the fan.

3. The DAC apparatus according to claim 1, further comprising:
a heat exchanger provided to be capable of exchanging heat with the adsorbent; and
a heat pump configured to cool the vacuum pump and transfer the heat from a low-temperature heat medium for cooling the adsorbent through the heat exchanger to a high-temperature heat medium for heating the adsorbent through the heat exchanger, wherein
when stopping the DAC apparatus, the controller controls and stops the heat pump and then controls the atmospheric valve and the vacuum valve to purge the vacuum piping and the vacuum pump.

4. The DAC apparatus according to claim 3, further comprising:
a temperature sensor configured to detect a temperature of the low-temperature heat medium; and
a heat dissipation portion configured to cool the low-temperature heat medium, wherein
the controller controls the heat dissipation portion to cool the low-temperature heat medium when the temperature of the low-temperature heat medium detected by the temperature sensor exceeds an upper limit temperature.

5. The DAC apparatus according to claim 4, further comprising:
a heater configured to heat the low-temperature heat medium, wherein
the controller controls the heater to heat the low-temperature heat medium when the temperature of the low-temperature heat medium detected by the temperature sensor is equal to or lower than a lower limit temperature.

6. The DAC apparatus according to claim 1, wherein
in the plurality of adsorption chambers, the adsorption step and the desorption step are sequentially performed by shifting timing, wherein
out of the adsorption chamber in which the adsorption step is being performed, the adsorption chamber in which the adsorption step was started first is determined as the purging adsorption chamber.

7. The DAC apparatus according to claim 6, wherein
in the plurality of adsorption chambers, a sequential order of performing the adsorption step and the desorption step is determined beforehand, wherein
when restarting the DAC apparatus after stopping the DAC apparatus, the controller controls the atmospheric valve and the vacuum valve to sequentially perform the desorption step from the adsorption chamber determined as the purging adsorption chamber in accordance with the sequential order.

8. The DAC apparatus according to claim 1, wherein
when purging the vacuum piping and the vacuum pump, the controller controls the vacuum valve to repeat permission and prohibition of the flow of the gas to the vacuum piping at predetermined time intervals.

9. The DAC apparatus according to claim 1, wherein
when purging the vacuum piping and the vacuum pump, the controller controls the vacuum pump to perform an intermittent operation of alternately repeating drive and stop.
